(19) United States
(12) Patent Application Publication
(10) Pub. No.: US 2009/0307000 A1
(43) Pub. Date: Dec. 10, 2009

(54) METHOD AND SYSTEM FOR GLOBALLY MONITORING AIRCRAFT COMPONENTS

(76) Inventors: Paul R. Scheid, West Hartford, CT (US); Rork S. Brown, Lexington, MD (US); William H. Beacham, Enfield, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/135,384

(22) Filed: Jun. 9, 2008

(51) Int. Cl. G06Q 99/00

(52) U.S. Cl. 705/1; 340/540

(57) ABSTRACT

A method for monitoring information of at least one unemployed aircraft components includes monitoring information relating to each of the unemployed aircraft components, transmitting the information from each location of each the unemployed aircraft components to a remotely located central control, and collecting the information in a computer-readable medium associated with the central control to thereby provide remote access of the information.

### BACKGROUND OF THE INVENTION

This disclosure relates to a method and system for globally monitoring unemployed aircraft components.

An aircraft component, such as gas turbine engine component, may be used on several aircraft. For example, over the lifetime of the component, the component may be employed on one aircraft for a period of time and later transplanted into a second aircraft. Additionally, the component may be removed periodically from an aircraft for testing or servicing.

Between uses, or even before an initial installation on an aircraft, the component is unemployed and may be in the possession of a customer, warehoused, transported between locations, transported between customers, serviced, tested, or otherwise handled prior to employment on an aircraft. Thus, it may be difficult for an owner or anyone remotely located from the component to monitor the location or status of the component. The difficulty in monitoring becomes even more complicated when there are many components in many different global locations. Thus, the difficulties in monitoring may result in the component being stolen or temporarily lost, tampered with, unintentionally damaged from mishandling, stored in an inappropriate manner or handled in an untimely manner, which may contribute to additional business expenses. These same conditions may apply to the containers that store and protect these components which can be expensive assets.

### SUMMARY OF THE INVENTION

The disclosed example methods and systems facilitate monitoring information relating to a plurality of unemployed aircraft components.

An example method includes monitoring information relating to each of a plurality of unemployed aircraft components, transmitting the information from each location of each plurality of unemployed aircraft components to a remotely located central control, and collecting the information in a computer-readable medium associated with the central control to thereby provide remote access of the information.

An example system includes a plurality of monitor devices associated with a plurality of unemployed aircraft components. The monitor devices monitor and transmit information relating to each of the unemployed aircraft components from locations of the plurality of unemployed aircraft components. A central control is located remotely from the plurality of monitor devices for collecting the information from the monitor devices.

Another example system includes a container associated with an unemployed aircraft component, and a monitor device associated with the container for monitoring information relating to the unemployed aircraft component.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates an example method for monitoring information of a plurality of unemployed aircraft components;

FIG. 2 illustrates an example system for monitoring information of a plurality of unemployed aircraft components;

FIG. 3 illustrates an example implementation of a method and system for monitoring information of a plurality of unemployed aircraft components;

FIG. 4 illustrates another example implementation of a method and system for monitoring information of a plurality of unemployed aircraft components;

FIG. 5 illustrates another example implementation of a method and system for monitoring information of a plurality of unemployed aircraft components; and

FIG. 6 illustrates another example implementation of a method and system for monitoring information of a plurality of unemployed aircraft components.

### DETAILED DESCRIPTION OF THE PREFERRED EMBODIMENT

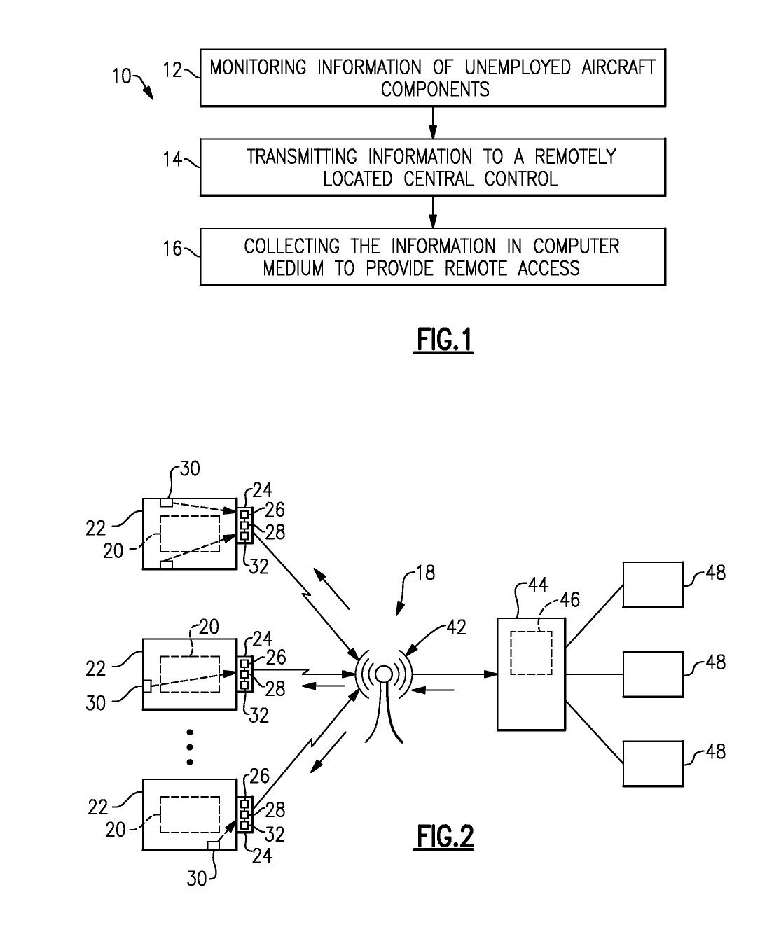

FIG. 1 illustrates an example method 10 for monitoring information relating to one or more unemployed aircraft components. The information may be used for any desired purpose, such as to manage or control logistics of the components. The information that is monitored may be any type of information about the unemployed aircraft components, as will be described in the examples below. The method 10 and example systems described herein may be used to facilitate monitoring aircraft components, such as to reduce risk of the aircraft components being stolen or temporarily lost, unintentionally damaged from mishandling, handled in an untimely or inefficient manner, for example.

The aircraft components may be any of a variety of different components typically employed in an aircraft. Furthermore, the aircraft components may be ones that are typically used on several different aircraft over a lifetime of the components or ones that are removed periodically from an aircraft for servicing, testing, or other purpose. The benefits of the example method 10 and systems may be particularly useful for monitoring large numbers of globally deployed aircraft components, aircraft components that are in the possession of a customer, components transported between locations, transported between customers, serviced, tested, or otherwise handled prior to employment on an aircraft. For example, the aircraft components may be gas turbine engine components or modules, such as a fan, gearbox, nozzle, compressor, combustor, or turbine or it could be aircraft components such as pumps, actuator, auxiliary power units, and air cycle machines. Thus, the method 10 and systems may be used to provide logistical tracking of aircraft components. Given this description, one of ordinary skill in the art will recognize other types of aircraft components that would benefit from the examples described herein.

With continued reference to FIG. 1, the example method 10 includes three steps 12, 14, and 16. Step 12 includes monitoring information about each of a plurality of unemployed aircraft components. Step 14 includes transmitting the information from a location of each the plurality of unemployed aircraft components to a remotely located central control, and step 16 includes collecting the information in a computer-readable medium associated with the central control to thereby provide remote access of the information about each of a plurality of unemployed aircraft components. This will lend itself to applications that can process this information, such as a logistics optimization system and trending and alerting.

FIG. 2 illustrates selected portions of an example system 18 for utilizing the method 10. In this example, multiple unemployed aircraft components 20 are stored in corresponding containers 22. For example, the term “unemployed” refers to aircraft components that are not installed on an aircraft. The containers 22 may be any suitable shape or type of container for storing or transporting the aircraft components 20, such as rigid enclosures or frames both large and small.

A monitoring device 24 is mounted on each container 22, for monitoring and controlling information about the respective aircraft component 20 in the container 22. The monitoring device 24 may be mounted internally or externally on a wall of the container 22, incorporated integrally within the walls of the container 22 or mounted in any other suitable manner. Alternatively, the monitor device 24 may be mounted on the unemployed aircraft component 20, or be moveable between the unemployed aircraft component 20 and the container 22.

The monitoring devices 24 may be any type of monitoring device that is suitable for monitoring a desired type of information about the aircraft components 20. In the disclosed example, one or more of the monitoring devices 24 includes a sensor 26 for collecting information about the unemployed aircraft component 20 and a transceiver 28 in communication with the sensor 26 for transmitting the information. The sensor 26 and the transceiver 28 may be interfaced using wired or wireless connections, for example.

The sensor 26 may be any type of sensor that is suitable for collecting a desired type of information. For example, the sensor 26 may include one or more of a shock sensor, a proximity sensor, a service switch sensor, or an orientation sensor. The shock sensor provides acceleration information about the unemployed aircraft component 20 and container 22 that may indicate possible damage to the unemployed aircraft component 20 by a collision or impact during ground or air transportation. The proximity sensor provides location information relative to a corresponding unemployed aircraft component and its container, as will be described more fully below. The service switch sensor provides information about the service state of the unemployed aircraft component 20. For example, an operator mechanic may manually toggle the service switch sensor between one position that indicates service of the unemployed aircraft component 20 is not complete and another position that indicates service of the unemployed aircraft component 20 is complete. The orientation sensor provides gyro or magnetometer information about the unemployed aircraft component 20 that may indicate possible damage to the unemployed aircraft component 20 due to improper handling.

Optionally, the monitor device 24 includes one or more additional sensors 30 mounted separately on each container 22, mounted on the unemployed aircraft component 20, or on an engine stand, for monitoring other information about the unemployed aircraft component 20. The sensors 30 are connected for communication with the transceiver 28, such as with a wired or wireless connection.

For example, the sensor 30 may include one or more of a humidity sensor, a light sensor, a proximity sensor, or a pressure sensor. The humidity sensor provides information about a humidity level within the container that may indicate the need to change a desiccant within the container 22 or that the humidity level has exceeded a desired threshold. The light sensor, such as a solar cell, provides information about whether a cover of the container 22 is or was opened. Likewise, the proximity sensor provides information about an open or closed position of a cover of the container 22. The pressure sensor provides air pressure information within a sealed container 22 holding the unemployed aircraft component 20. Thus, the sensor 26 and/or sensor 30 may collect information about one or more physical conditions of the unemployed aircraft component 20.

In the disclosed example, the monitoring device 24 may also include one or more other devices 32 for providing other types of information. For example, the device 32 may be an electronic tag, such as a radio frequency identification, a global position (i.e., “GPS”) device, an audible alert device (e.g., an actuated audible device), a memory device, a computer processing unit, or a hardware unit for employing software to control the sensors 26, 30 and transceiver 28.

The device 32 is in communication with the transceiver 28 for transmitting the collected information. For example, the electronic tag may provide information about the type of unemployed aircraft component 20, such as a serial number, part number or other pertinent information about the monitored component. The GPS device may provide speed, direction, or location information, for tracking global position and movement of the unemployed aircraft component 20. The audible alert device may provide locating information, as will be described below. The memory device, computer processing unit, hardware, and software may be used to store information, to control operation of the monitor device 24, or to provide security encryption, for example.

As can be appreciated, one or more of the sensors 26, 30, transceiver 28, and device 32 as described above may be integrated into a single module or used separately, depending on the needs of a particular implementation.

The transceiver 28 transmits the collected information over a network 42 to a central control 44. The transceiver 28 may be any suitable type of transceiver for wirelessly communicating over the network 42 and include a transmitter such as a GPS transmitter, radio frequency transmitter, or Iridium transmitter, for example. Likewise, the network 42 can be any suitable type of network, such as a land-based network, a satellite network, a local area network, a wide area network, or combinations thereof.

In the disclosed example, the central control 44 includes a computer-readable medium 46. For example, the computer-readable medium may be a memory device that cooperates with software and/or other hardware to organize the information from the monitor devices 24 in a desired manner, such as in a database. The central control 44 may also include or cooperate with a server to provide the information to client devices 48, such as remotely located computers or communication devices (e.g., servers, wireless handheld devices). These client devices may be accessed by owners, operators and maintainers.

In operation, the monitor devices 24 collect and transmit the information through the network 42 to the central control 44. The central control 44, the client devices 48, or even the user may then utilize the information for any variety of reasons, depending on the type of information. For example, one or more physical conditions of the unemployed aircraft component 20 may be monitored and compared to predetermined thresholds. The predetermined thresholds may correspond to undesirable physical conditions of the unemployed aircraft component 20, such as conditions that may cause damage to the component 20. Certain types of bearings, seals, or other subcomponents of the component 20 may be sensitive to particular physical conditions.

A particular predetermined threshold depends on the type of physical condition and judgment criteria. For example, the predetermined threshold may be a numerical range, a maximum or minimum value, or a binary indicator, such as a signal representing an occurrence or a non-occurrence.

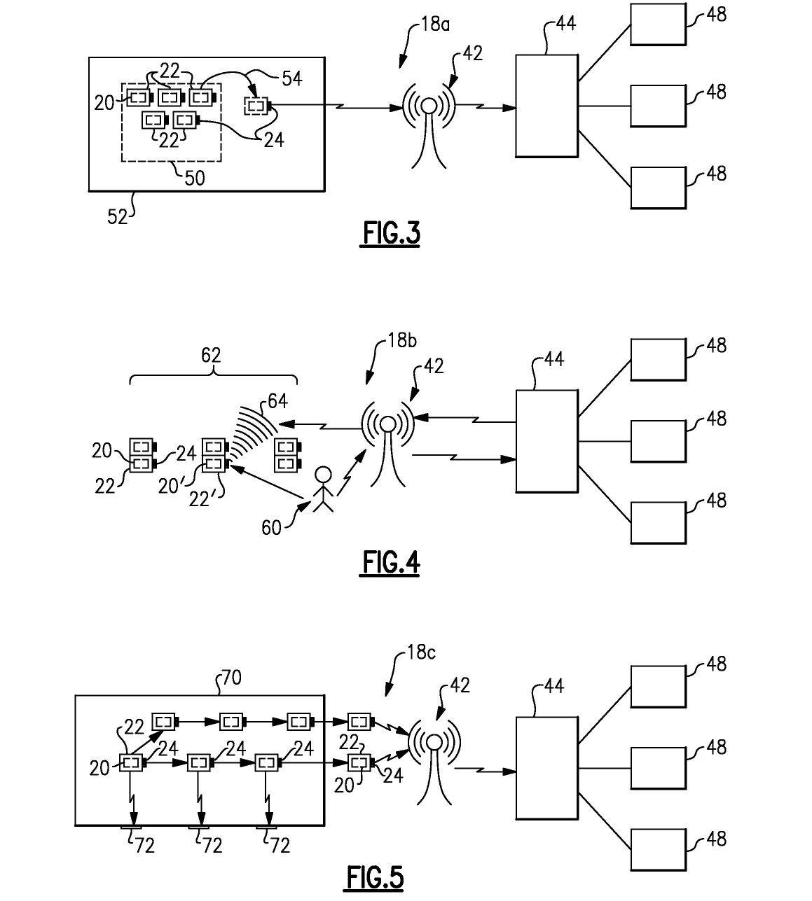

FIG. 3 illustrates an example implementation of the method 10 and a system 18a similar to system 18 described above. In this disclosure, like reference numerals designate like elements where appropriate, and reference numerals with the addition of a letter designate modified elements. The modified elements incorporate the same features and benefits of other modified elements, except where stated otherwise. In this example, the containers 22 and unemployed aircraft components 20 are shown somewhat simplistically, but include the monitor devices 24 as described in the previous examples. The containers 22 are stored within a storage area 50 of a storage location 52. For example, the storage location 52 is a geographical region, an airport, a storage facility or the like, and the storage area 50 is a relatively smaller geographical region, facility, or area within the storage location 52.

In this example, the unemployed aircraft components 20 are monitored as a tracking or security measure relative to the storage area 50. For example, location information collected by the GPS devices of the monitor devices 24 is used to determine whether the containers 22 and unemployed aircraft components 20 have been removed from the storage area 50, as indicated by arrow 54. As a tracking measure, a user can determine whether one or more of the containers 22 and unemployed aircraft components 20 were shipped from the storage area 50. As a security measure, a user can determine whether one or more of the containers 22 and unemployed aircraft components 20 were moved from the storage area 50 against authorization. Given this description, one of ordinary skill in the art will recognize other tracking or security implementations that meet their particular needs.

In some examples, the software, hardware, or combination thereof within the monitor devices 24 or central control 44 may automatically determine for the user whether one or more of the containers 22 and unemployed aircraft components 20 were moved out of the storage area 50. For example, the central control 44 may issue an alert to the user, depending on preset information entered into the central control 44, such as coordinates of the storage area 50 and storage location 52. The alert may be in the form of an audible alert, email message, cellular text message, or other desired type of alert.

FIG. 4 illustrates another example implementation of the method 10 and a system 18b that is similar to the system 18 as described in the examples of FIGS. 1 and 2. In this example, the containers 22 and unemployed aircraft components 20 are shown somewhat simplistically, but include the monitor devices 24 as described in previous examples. In this example, a user 60 desires to find a particular container 22′ and unemployed aircraft component 20′ among a group 62. However, there may be a relatively large number of containers 22 in the group, thereby making it difficult to locate the container 22′. The user 60 may then utilize the system 18 to trigger an audible alert from the audible alert device of the monitor device 24 of the container 22′. For example, the user 60 may communicate a request for the audible alert through the network 42 to the central control 44. The request may be made using a computer or other type of communication device, such as a wireless handheld device. Alternatively, the request may be made to an operator located at a client device 48, or directly to the monitoring devices 24 using a handheld device.

In response to the request, the central control 44 transmits an activation signal through the network 42 and transceiver 28 to the audible device of the container 22′. The audible device then emits an audible alert 64 that aids the user 60 in locating the container 22′ among the group 62. Likewise, other information may be transmitted to the monitor device 24 using the transceiver 28, as will be described below.

FIG. 5 illustrates another implementation of the method 10 and a system 18c that is similar to the system 18 as described in the examples of FIGS. 1 and 2. In this example, the containers 22 and unemployed aircraft components 20 are shown somewhat simplistically, but include the monitor devices 24 as in the previous examples. The containers 22 are in a storage area 70, such as a storage facility that disrupts or blocks communication (indicated at 72). In this example, the monitor devices 24 of the containers 22 include software, hardware, or combinations thereof that detect whether connectivity is strong enough to transmit the information directly to the network 42. If the connectivity is weak or non-existent, the monitor devices 24 route the information between monitor devices 24 to a monitor device 24 having sufficient connectivity to transmit to the network 42. In this regard, one of the monitor devices 24 functions as a host for the other monitor devices 24.

In the illustrated example, the monitor devices 24 of the containers 22 within the storage area 70 communicate the information to one or more transceivers 28 of monitor devices 24 of containers 22 located outside of the storage area 70 having sufficient connectivity. Optionally, the information may be encrypted in a known manner to facilitate security.

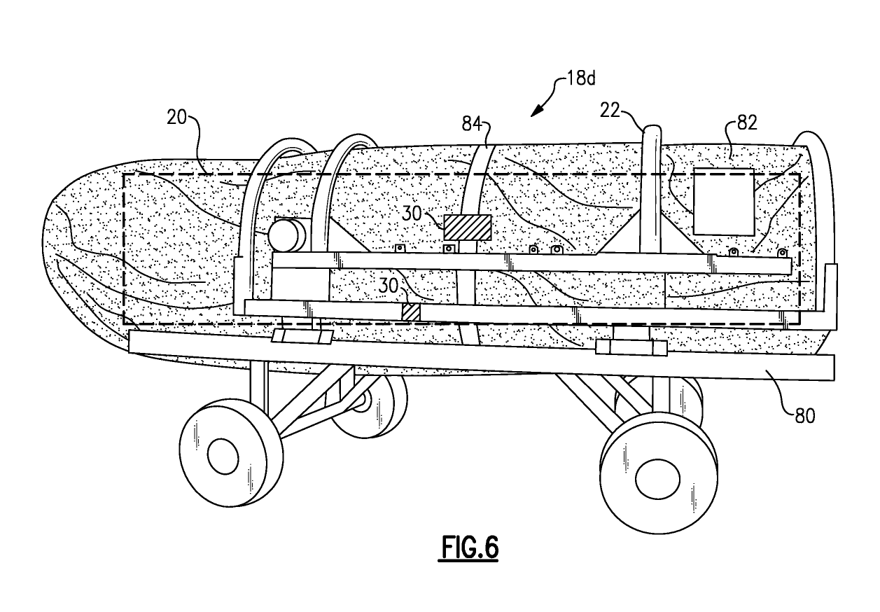

FIG. 6 illustrates another example implementation of the method 10 and portions of a system 18d that is similar to the system 18 described in the examples of FIGS. 1 and 2. In this example, the containers 22 and unemployed aircraft components 20 are on an engine stand 80 and covered by a tarp 82. Alternatively, the unemployed aircraft components 20 are installed in the containers 22 and placed on the engine stand 80, such as in an assembled state of a gas turbine engine. The tarp is secured with a security device 84, such as a belt or strap that includes one of the sensors 30. In this example, the sensor 30 is an electrical continuity sensor that cooperates with a locking latch or buckle of the security device 84 to provide information about whether the tarp is secured on the unemployed aircraft component 20. For example, the tarp information may indicate whether the unemployed aircraft component 20 is being serviced or not. It could also indicate tampering of the unemployed aircraft component 20.

Additionally, the sensor 30 on the security device 84, another of the sensors 30 on the unemployed aircraft component 20 or container 22 as discussed above, another of the sensors 30 on the engine stand 80, or combinations thereof may be a proximity sensor for providing information about whether the unemployed aircraft components 20 are on the engine stand 80 or not, or to track availability of the engine stand 80 among a group of engine stands.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for monitoring information relating to a plurality of unemployed aircraft components, comprising:
monitoring information about each of a plurality of unemployed aircraft components;
transmitting the information from a location of each the plurality of unemployed aircraft components to a remotely located central control; and
collecting the information in a computer-readable medium associated with the central control to thereby provide remote access of the information about each of a plurality of unemployed aircraft components.

2. The method as recited in claim 1, further comprising the step of monitoring global positions of the plurality of unemployed aircraft components.

3. The method as recited in claim 1, further comprising the step of wirelessly transmitting the information over a network.

4. The method as recited in claim 1, further comprising the step of monitoring a physical condition of each respective one of the plurality of unemployed aircraft components.

5. The method as recited in claim 4, further comprising the step of establishing an alert if the physical condition is outside of a predetermined threshold.

6. The method as recited in claim 1, further comprising the step of monitoring humidity information of the plurality of unemployed aircraft components.

7. The method as recited in claim 1, further comprising the step of monitoring acceleration information of the plurality of unemployed aircraft components.

8. The method as recited in claim 1, further comprising the step of monitoring proximity information of a relative position between at least one of the plurality of unemployed aircraft components and an engine stand.

9. The method as recited in claim 1, further comprising the step of monitoring position information of a cover of a container having at least one of the plurality of unemployed aircraft components.

10. The method as recited in claim 1, further comprising the step of monitoring component identification information of at least one of the plurality of unemployed aircraft components.

11. The method as recited in claim 1, further comprising the step of monitoring air pressures within at least one of the plurality of unemployed aircraft components containers.

12. The method as recited in claim 1, further comprising the step of monitoring a physical condition of tarps covering at least one of the plurality of unemployed aircraft components.

13. The method as recited in claim 1, further comprising the step of monitoring a service state of at least one of the plurality of unemployed aircraft components.

14. The method as recited in claim 1, further comprising the step of transmitting the information between locations of at least a portion of the plurality of unemployed aircraft components.

15. The method as recited in claim 1, further comprising the step of monitoring container condition information of containers having the plurality of unemployed engine components.

16. A system for monitoring information relating to at least one unemployed aircraft component, comprising:
at least one monitor device associated with each respective one of at least one unemployed aircraft component, for monitoring and transmitting information about the at least one unemployed aircraft component from a location of the at least one unemployed aircraft component; and
a central control located remotely from the at least one monitor device, for collecting the information from the at least one monitor device.

17. The system as recited in claim 16, wherein the at least one monitor device has a transmitter for transmitting the information.

18. The system as recited in claim 16, wherein the at least one monitor device has a sensor for monitoring the information.

19. The system as recited in claim 16, wherein the at least one monitor device includes at least one of a global position system, humidity sensor, a continuity sensor, a shock sensor, a component installed proximity sensor, a light sensor, a pressure sensor, a service switch sensor, a radio frequency tag, a container cover proximity sensor, an audible alert device, or an orientation sensor.

20. The system as recited in claim 16, wherein the at least one monitor device is attached to each respective one of at least one container for at least partially enclosing the at least one unemployed aircraft component.

21. The system as recited in claim 16, further comprising a wireless network for establishing communication between the at least one monitor device and the central control.

22. A system for monitoring information relating to an unemployed aircraft component, comprising:
a container associated with an unemployed aircraft component; and
a monitor device associated with the container for monitoring physical condition information relating to the unemployed aircraft component.

23. The system as recited in claim 22, wherein the monitor device comprises a sensor for monitoring the physical condition information and a transmitter for transmitting the physical condition information.

24. The system as recited in claim 22, wherein the monitor device includes at least one of a global position system, a humidity sensor, a continuity sensor, a shock sensor, a component installed proximity sensor, a light sensor, a pressure sensor, a service switch sensor, a radio frequency tag, a container cover proximity sensor, an audible alert device, or an orientation sensor.
